(19) United States
(12) Patent Application Publication
(10) Pub. No.: US 2025/0110225 A1
(43) Pub. Date: Apr. 3, 2025

(54) ICE BLOCKAGE DETECTION AND MITIGATION FOR ULTRASONIC SENSORS

(71) Applicant: Robert Bosch GmbH, Stuttgart (DE)

(72) Inventors: Michael T. White, Livonia, MI (US); Paul J. Connor, Belleville, MI (US); Majed J. Sabbagh, Northville Township, MI (US)

(21) Appl. No.: 18/476,777

(22) Filed: Sep. 28, 2023

(51) Int. Cl. G01S 7/52; G01S 15/931

(52) U.S. Cl. CPC G01S 7/52004; G01S 15/931; G01S 2007/52011

(57) ABSTRACT

Systems and methods for ice removal system for an ultrasonic sensor. One example system includes the ultrasonic sensor including a transducer and an electronic processor. The electronic processor is configured to output, at the transducer, a chirp signal. The electronic processor is configured to determine, based on the chirp signal, whether a mechanical impedance is present at the transducer. The electronic processor is configured to, in response to determining that the mechanical impedance is present, output, at the transducer, a frequency sweep signal. The electronic processor is configured to receive, at the transducer, a reflected frequency sweep signal. The electronic processor is configured to determine, based on the reflected frequency sweep signal, a resonant frequency. The electronic processor is configured to output, at the transducer, an output signal according to the resonant frequency.

### BACKGROUND

Ultrasonic sensors are utilized in object detection systems (for example, those in vehicles).

### SUMMARY

An ultrasonic sensor is a device that emits ultrasonic sound and measures the distance between the sensor and an object based on a reflection of the emitted sound. The reflected sound is converted into an electrical signal. The distance may be determined based on the time elapsed between the generation of the sound and receipt of the reflection. Ultrasonic sensors are used in many applications. For example, ultrasonic sensors are used in advanced driver-assistant systems (ADAS) provided in vehicles including parking assist systems, and certain other systems that involve object detection.

In certain environments, ultrasonic sensors may be exposed to conditions where snow or ice builds up on the sensor (in particular, on the transducer). This may reduce the effectiveness of ultrasonic sensor's ability to transmit and receive signals properly.

Some existing systems utilize one or more heating elements to mitigate ice build-up on an ultrasonic sensor of a vehicle. However, such systems may be expensive to implement and maintain. It would be beneficial if there was a control system that utilizes the functionality of the ultrasonic sensor itself without the need for additional components.

Accordingly, examples and aspects described herein provide, among other things, a system and a method for mitigating blockage on an ultrasonic sensor.

One example provides an ice removal system for an ultrasonic sensor. The system includes the ultrasonic sensor including a transducer and an electronic processor. The electronic processor is configured to output, at the transducer, a chirp signal. The electronic processor is configured to determine, based on the chirp signal, whether a mechanical impedance is present at the transducer. The electronic processor is configured to, in response to determining that the mechanical impedance is present, output, at the transducer, a frequency sweep signal. The electronic processor is configured to receive, at the transducer, a reflected frequency sweep signal. The electronic processor is configured to determine, based on the reflected frequency sweep signal, a resonant frequency. The electronic processor is configured to output, at the transducer, an output signal according to the resonant frequency.

Another example provides a method for removing ice for an ultrasonic sensor. The method includes outputting, at a transducer of the sensor, a chirp signal. The method includes determining with an electronic processor, based on the chirp signal, whether a mechanical impedance is present at the transducer. The method includes in response to determining that the mechanical impedance is present, outputting, at the transducer, a frequency sweep signal. The method includes receiving, at the transducer, a reflected frequency sweep signal. The method includes determining, based on the reflected frequency sweep signal, a resonant frequency. The method includes outputting, at the transducer, an output signal according to the resonant frequency.

Other aspects, features, and examples will become apparent by consideration of the detailed description and accompanying drawings.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate examples and aspects of concepts that include the claimed subject matter and explain various principles and advantages of various aspects and examples.

FIG. 1 is a block diagram of an ultrasonic sensor system, in accordance with some aspects.

FIG. 2 is a cutaway view of an ultrasonic sensor of the system of FIG. 1 in accordance with some aspects.

FIG. 3 schematically illustrates an electronic controller of the system of FIG. 1, in accordance with some aspects.

FIG. 4 is a flowchart of an example method for mitigating ice blockage on an ultrasonic sensor of the system of FIG. 1, in accordance with some aspects.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of examples and aspects.

The apparatus and method components have been represented where appropriate by conventional symbols in the drawings, showing only those specific details that are pertinent to understanding the examples so as not to obscure the disclosure with details that will be readily apparent to those of ordinary skill in the art having the benefit of the description herein.

### DETAILED DESCRIPTION

Before any embodiments, examples, aspects, and features are explained in detail, it is to be understood that they are not limited in their application to the details of construction and the arrangement of components set forth in the following description or illustrated in the following drawings. Other embodiments, examples, aspects, and features are possible, and they are capable of being practiced or of being carried out in various ways.

For ease of description, some or all of the example systems presented herein are illustrated with a single exemplar of each of its component parts. Some examples may not describe or illustrate all components of the systems. Other examples may include more or fewer of each of the illustrated components, may combine some components, or may include additional or alternative components.

It will be appreciated that some examples may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory.

It should be understood that although certain drawings illustrate hardware and software located within particular devices, these depictions are for illustrative purposes only. In some examples, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among multiple different devices. Accordingly, in the claims, if an apparatus, method, or system is claimed, for example, as including a controller, control unit, electronic processor, computing device, logic element, module, or other element configured in a certain manner, for example, to perform multiple functions, the claim or claim element should be interpreted as meaning one or more of such elements where any one of the one or more elements is configured as claimed, for example, to make any one or more of the recited multiple functions, such that the multiple elements, as a set in a collective nature, perform the multiple functions.

Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting, and coupling. Further, “connected” and “coupled” are not restricted to physical or mechanical connections or couplings, and can include electrical connections or couplings, whether direct or indirect. The term “predetermined” means specified prior to an event. Also, electronic communications and notifications may be performed using any known means including direct connections (e.g., wired or optical), wireless connections, or other communication.

The systems and methods described herein may be used independently (e.g., as alternatives) or in various combinations. Although the systems and methods are described herein in regard to an ice blockage on an ultrasonic sensor, it should be understood that the systems and methods described herein may also be applied to other kinds of acoustic sensors. The examples described herein may also be applicable to other kinds of detection systems beyond automotive applications.

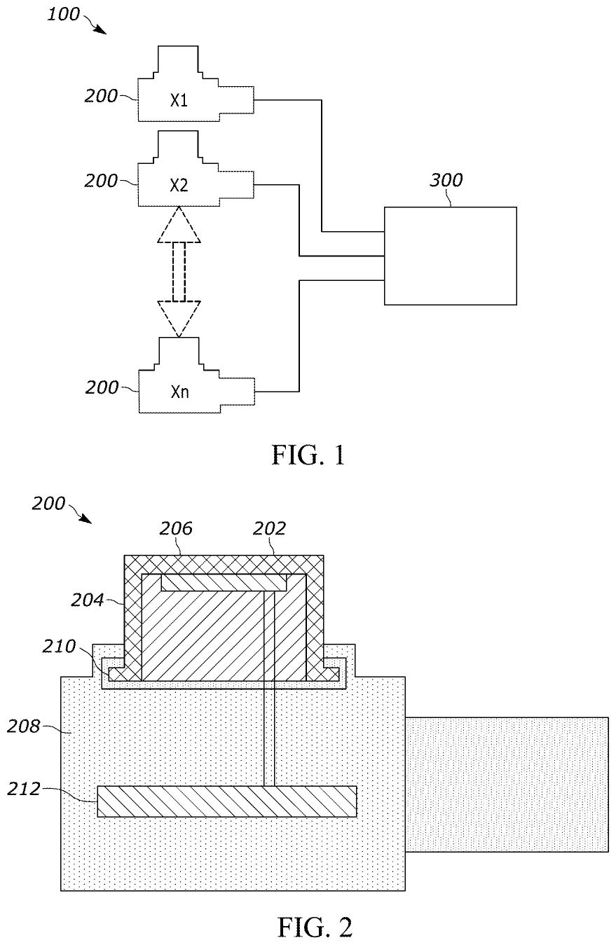

FIG. 1 illustrates an ultrasonic detection system 100 according to some examples. The ultrasonic detection system 100 may be, for example, an advanced driver assistance system for a vehicle (not shown).

In the example illustrated, the system 100 includes one or more ultrasonic sensors 200 and an electronic controller 300. Each of the ultrasonic sensors 200 is communicatively coupled to the electronic controller 300. The components of the system 100, along with other various modules and components are electrically coupled to each other by or through one or more control or data buses, which enable communication therebetween. For example, in some instances, the components of the system 100 communicate according to a Controller Area Network (CAN™) protocol. In some instances, one or more of the buses include an Ethernet™, a FlexRay™ communications bus, or another suitable wired bus. In alternative instances, some or all of the components of the system 100 may be communicatively coupled using suitable wireless modalities (for example, Bluetooth™). For ease of description, the system 100 illustrated in FIG. 1 includes one of each of the foregoing components. Alternative instances may include one or more of each component or may exclude or combine some components.

The ultrasonic sensor 200 is configured to output ultrasonic sound and detect sound that is reflected off of an object within a range of the sensor (for example, up to approximately 5.5 meters). As noted above, the time (T) between generation of the sound and receipt of the reflection may be used to determine a distance between the sensor 200 and the object. For example, assuming the speed of sound (Vₛ) in air is known and the distance travelled by the sound is twice the distance to the object (the sound travels out to the object and the reflection travels back to the sensor) the distance (D) may be determined as follows: D=T*Vₛ/2. Of course, a more nuanced calculation may be carried out to, for example, generate more accurate determinations.

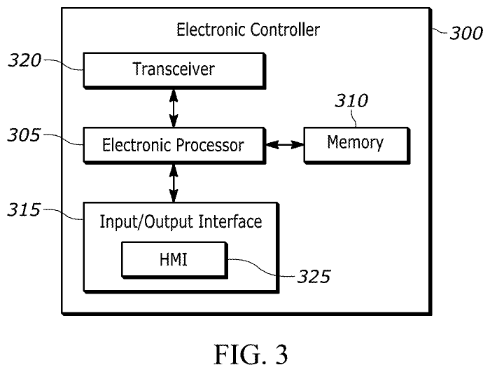

FIG. 2 is a cutaway diagram of the ultrasonic sensor 200 in accordance with some examples. As illustrated, the ultrasonic sensor 200 includes a transducer 202 including a membrane 204 and a piezo element 206. The transducer 202 is mechanically coupled to a housing 208 of the sensor 200 via a decoupling ring 210. The sensor 200 includes, within the housing 208, a circuit board 212 that includes one or more switches to selectively provide power to and receive voltage signals from the piezo element 206 according to commands received from the electronic controller 300. The membrane 204 is configured to amplify and shape the sound transmission envelope of the transducer 202.

In the illustrated example, the transducer 202 is a piezoelectric transducer. However, in some examples, the transducer 202 is a micro-electromechanical transducer or another kind of ultrasonic sound transducer. In some examples, the transducer 202 is configured to both transmit and receive ultrasonic sound (which may also be referred to as signals). Alternatively, the transducer 202 may be a transmitter-receiver pair of separate transducers. During operation, the transducer 202 emits one or more ultrasonic signals at one or more particular frequencies. The reflected signal is received at the transducer 202 (in particular, at the piezo element 206) and is evaluated via the controller 300.

The electronic controller 300 (described more particularly below with respect to FIG. 3) operates and receives information from the sensor 200 to determine whether an object is present within range of the ultrasonic sensor 200. In some embodiments, some or all of the components and functionality of the electronic controller 300 described herein may be integrated into the ultrasonic sensor 200. For example, in some instances, the sensor 200 includes on-board signal processing circuitry (for example, on the circuit board 212), which produces and transmits sensor information including measurements to the electronic controller 300 for processing. The electronic controller 300 receives and interpret the signals received from the sensor 200 to determine one or more characteristics of the reflected signal.

The example illustrated in FIG. 2 provides but one example of the components of the sensor 200. However, these components and connections may be constructed in other ways than those illustrated and described herein. In some embodiments, the ultrasonic sensor 200 may be a different kind of sensor.

FIG. 3 is a block diagram of the electronic controller 300 of the system 100. The electronic controller 300 includes a plurality of electrical and electronic components that provide power, operation control, and protection to the components and modules within the electronic controller 300. The electronic controller 300 includes, among other things, an electronic processor 305 (such as a programmable electronic microprocessor, microcontroller, or similar device), a memory 310 (for example, non-transitory, computer readable memory), and an input/output interface 315. In some examples, the electronic controller 300 further includes a transceiver 320. The electronic processor 305 is communicatively connected to the memory 310, the input/output interface 315, and the transceiver 320. The input/output interface 315, in some examples, includes a human machine interface (HMI) 325. The electronic processor 305, in coordination with the memory 310 and the input/output interface 315, is configured to implement, among other things, the methods described herein.

The memory 310 may be made up of one or more non-transitory computer-readable media and includes at least a program storage area and a data storage area. The program storage area and the data storage area can include combinations of different types of memory, such as read-only memory (“ROM”), random access memory (“RAM”), flash memory, or other suitable memory devices. The electronic processor 305 is coupled to the memory 310 and the input/output interface 315.

The electronic processor 305 sends and receives information (for example, from the memory 310 and/or the input/output interface 315) and processes the information by executing one or more software instructions or modules, capable of being stored in the memory 310, or another non-transitory computer readable medium. The software can include firmware, one or more applications, program data, filters, rules, one or more program modules, and other executable instructions. The electronic processor 305 is configured to retrieve from the memory 310 and execute, among other things, software for blockage detection and mitigation of the sensor 200 and for performing methods as described herein.

The input/output interface 315 transmits and receives information from devices external to the electronic controller 300 (for example, over one or more wired and/or wireless connections), for example, components of the system 100 via one or more data buses and/or designated communication channels. The input/output interface 315 receives input (for example, from the ultrasonic sensor 200), provides system output (for example, to the transceiver 320 and/or the HMI 325, etc., or a combination of both). The input/output interface 315 may also include other input and output mechanisms, which for brevity are not described herein and which may be implemented in hardware, software, or a combination of both.

The transceiver 320 includes a radio transceiver communicating data over one or more wireless communications networks (for example, cellular networks, satellite networks, land mobile radio networks, etc.). The transceiver 320 may also provide wireless communications within the system 100 using suitable network modalities (for example, Bluetooth™, near field communication (NFC), Wi-Fi™, and the like). Accordingly, the transceiver 320 communicatively couples the electronic controller 300 and other components of the system 100 with networks or electronic devices both inside and outside of the system 200. For example, the electronic controller 300, using the transceiver 320, can communicate with a one or more devices to send and receive data, commands, and other information (for example, notifications regarding blockage on the sensor 200). The transceiver 320 includes other components that enable wireless communication (for example, amplifiers, antennas, baseband processors, and the like), which for brevity are not described herein and which may be implemented in hardware, software, or a combination of both. Some instances include multiple transceivers or separate transmitting and receiving components (for example, a transmitter and a receiver) instead of a combined transceiver.

As mentioned above, the input/output interface 315 includes the HMI 325. The HMI 325 provides visual output, such as, for example, graphical indicators (i.e., fixed or animated icons), lights, colors, text, images, combinations of the foregoing, and the like. The HMI 325 includes a suitable display mechanism for displaying the visual output, such as, for example, an instrument cluster, a heads-up display, a center console display screen (for example, a touch screen, or other suitable mechanisms. In some instances, the HMI 325 displays a graphical user interface (GUI) (for example, generated by the electronic controller 300 and presented on a display screen) that enables a user to interact with one or more systems (and components thereof) the system 100. The HMI 325 may also provide audio output to the user such as a chime, buzzer, voice output, or other suitable sound through a speaker included in the HMI 325 or separate from the HMI 325. In some instances, HMI 325 provides a combination of visual, audio, and haptic outputs. In some examples, the HMI 325 is implemented on a separate electronic device of a user. The electronic device may be any kind of computing device such as a laptop, tablet, or a smart phone.

In some instances, the electronic controller 300 may be implemented in several independent controllers (for example, programmable electronic controllers) each configured to perform specific functions or sub-functions. For example, as mentioned above, one or more components of the controller 300 may be implemented on the sensor 200. As another example, one or more of the components of the controller 300 may be implemented on a separate controller (for example, a vehicle control unit). Additionally, the electronic controller 300 may contain sub-modules that include additional electronic processors, memory, or circuits for handling input/output functions, processing of signals, and application of the methods listed below. In other instances, the electronic controller 300 includes additional, fewer, or different components. Thus, the programs may also be distributed among one or more processors.

As described above, in some environments, ice may build up around the sensor 200. In instances where the ice builds up around the transducer 202, such a blockage may degrade proper operation of the transducer 202.

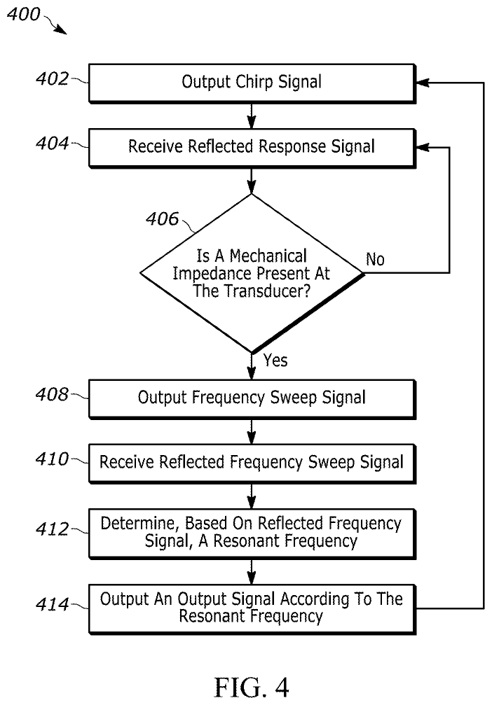

FIG. 4 illustrates an example of a method 400 for detecting and mitigating an ice blockage on an ultrasonic sensor (for example, the sensor 200 of the system 100). Although the method 400 is described in conjunction with the system 100 as described herein, the method 400 could be used with other systems. In addition, the method 400 may be modified or performed differently than the specific example provided. As an example, the method 400 is described as being performed by the electronic controller 300 and, in particular, the electronic processor 305. However, it should be understood that in some instances, portions of the method 400 may be performed by other devices or subsystems of the system 100.

At block 402, the electronic processor 305 outputs, via the transducer, a chirp signal. The chirp signal is a sweep signal that increases (or decreases) in frequency over a predetermined amount of time. The chirp signal operates as a test signal, not a reflected (i.e., out of and back into the sensor) signal. It is a lower power signal (as compared to the frequency sweep signal), which does not propagate far beyond the membrane. At block 404, the electronic processor 305 determines, based on the chirp signal, whether there is a mechanical impedance of the transducer 202. The piezo element 206 has a characteristic response in voltage curve, amperage curve, and timing of peaks and valleys which when blocked would have different responses than unblocked. The electronic processor 305, for example, evaluates one or more voltage characteristics, current characteristics, or both of the piezo element 206 during transmission of the chirp signal and compares the characteristics to one or more predetermined thresholds corresponding to a normal operation of the sensor 200. In instances where there is an ice blockage on the sensor 200, the transducer 202 may not vibrate as well compared to normal operation of the sensor 200. By analyzing the electrical and vibrational responses to the reflected response signal, the electronic processor 305 determines the nature of any impedance to the vibrational movement of the transducer 202.

The electronic processor 305, at block 408, outputs via the transducer, in response to determining that the mechanical impedance is present, a frequency sweep signal. The electronic processor 305 then receives a reflected frequency sweep signal (block 410) and determines, based on the reflected frequency sweep signal, a resonant frequency (block 412). The electronic processor 305 then outputs, at the transducer, an output signal according to the resonant frequency (block 414).

The resonant frequency is a frequency that is the same as the natural frequency of the ice blockage of the ultrasonic sensor 200. The output signal causes the transducer 202 to vibrate at the resonant frequency and, due to the contact between the sensor 200 and the ice blockage, causes the ice blockage to oscillate and potentially fracture. The electronic processor 305 may determine the resonant frequency based on one or more signal characteristics of the reflected frequency sweep signal. For example, the electronic processor 305 may compare the reflected frequency sweep signal to one or more predetermined signal profiles stored in the memory 310.

In some examples, prior to block 408, the electronic processor 305 determines (for example, via one or more temperature sensors, which are not shown) whether an air temperature of the environment surrounding the system 100 is below a predetermined threshold (for example, below freezing). In instances where the electronic processor 305 determines that the temperature is below the predetermined temperature, the electronic processor 305 proceeds to block 406. Otherwise, in instances where the temperature is not below the predetermined temperature, the electronic processor 305 may output an alert to a user of the system 100 (for example, via the HMI 325) indicating that the sensor 200 may need maintenance.

Following block 414, the electronic processor 305 may return to block 402 after a predetermined amount of time (for example, 500 ms) to determine whether the blockage is still present. For example, the electronic processor 305, following block 414, outputs a second chirp signal via the transducer and receives a second reflected response signal. The electronic processor 305 then determines, from the second reflected response signal, whether the mechanical impedance is still present. In instances where the electronic processor 305 determines that the mechanical impedance is still present, the electronic processor 305 outputs a second frequency sweep signal and determines a second resonant frequency. The electronic processor 305 then outputs, at the transducer, the second output signal at the second resonant frequency.

The electronic processor 305 may adjust a duration of the output signal based on whether the amount of mechanical impedance is detected to be increasing or decreasing. For example, the electronic processor 305 may store a counter for each iteration the electronic processor 305 repeats the method 400 because the mechanical impedance is not lowering. When the counter exceeds a predetermined max limit, the electronic processor 305 may perform a different mitigation action. For example, the electronic processor 305 may generate an alert to a user of the system 100 (for example, via the HMI 325) indicating that the sensor 200 may need maintenance. As another example, the electronic processor 305 may provide a lower amount of power to the transducer 202 for a predetermined amount of time (for example, approximately 10 minutes), causing the transducer 202 to generate heat. The generated heat transfers through the membrane 204 and, thus, may melt the ice blockage on the membrane 204. In some examples, the electronic processor 305 may disable use of the sensor 200.

Thus, the examples described herein provide, among other things, systems and methods for mitigating an ice blockage on an ultrasonic sensor.

In the foregoing specification, specific examples, aspects, and features have been described. However, one of ordinary skill in the art appreciates that various modifications and changes can be made without departing from the scope of the aspects, examples, and features as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

Various features, aspects, advantages, and examples are set forth in the following claims.

1. An ice removal system for an ultrasonic sensor, the system comprising:
the ultrasonic sensor including a transducer; and
an electronic processor configured to
output, at the transducer, a chirp signal,
determine, based on the chirp signal, whether a mechanical impedance is present at the transducer,
in response to determining that the mechanical impedance is present, output, at the transducer, a frequency sweep signal,
receive, at the transducer, a reflected frequency sweep signal,
determine, based on the reflected frequency sweep signal, a resonant frequency, and
output, at the transducer, an output signal according to the resonant frequency.

2. The system of claim 1, wherein the electronic processor is further configured to:
output at the transducer, following outputting the output signal, a second chirp signal;
receive, at the transducer, a second reflected response signal, and
determine, from the second reflected response signal, whether the mechanical impedance is still present.

3. The system of claim 2, wherein the electronic processor is further configured to:
in response to determining that the mechanical impedance is still present, output, at the transducer, a second frequency sweep signal;
receive, at the transducer, a second reflected frequency sweep signal,
determine, based on a second received frequency sweep signal, a second resonant frequency, and
output, at the transducer, the second output signal at the second resonant frequency.

4. The system of claim 2, wherein the electronic processor is further configured to:
in response to determining that the mechanical impedance is still present, provide power to the transducer for a predetermined amount of time.

5. The system of claim 1, wherein the transducer is a piezoelectric transducer.

6. The system of claim 1, wherein the resonant frequency corresponds to an ice blockage on the transducer.

7. The system of claim 1, wherein the ultrasonic sensor is part of an advanced driver-assistance system of a vehicle.

8. A method for removing ice for an ultrasonic sensor, the method comprising:
outputting, at a transducer of the sensor, a chirp signal,
determining with an electronic processor, based on the chirp signal, whether a mechanical impedance is present at the transducer,
in response to determining that the mechanical impedance is present, outputting, at the transducer, a frequency sweep signal,
receiving, at the transducer, a reflected frequency sweep signal,
determining, based on the reflected frequency sweep signal, a resonant frequency, and
outputting, at the transducer, an output signal according to the resonant frequency.

9. The method of claim 8, further comprising:
outputting at the transducer, following outputting the output signal, a second chirp signal;
receiving, at the transducer, a second reflected response signal, and
determine, from the second reflected response signal, whether the mechanical impedance is still present.

10. The method of claim 9, further comprising:
in response to determining that the mechanical impedance is still present, outputting, at the transducer, a second frequency sweep signal;
receiving, at the transducer, a second reflected frequency sweep signal,
determining, based on a second received frequency sweep signal, a second resonant frequency, and
outputting, at the transducer, the second output signal at the second resonant frequency.

11. The method of claim 9, further comprising:
in response to determining that the mechanical impedance is still present, providing power to the transducer for a predetermined amount of time.

12. The method of claim 8, wherein the transducer is a piezoelectric transducer.

13. The method of claim 8, wherein the resonant frequency corresponds to an ice blockage on the transducer.

14. The method of claim 8, wherein the ultrasonic sensor is part of an advanced driver-assistance system of a vehicle.
